(19) United States
(12) Patent Application Publication
(10) Pub. No.: US 2025/0172061 A1
(43) Pub. Date: May 29, 2025

(54) WELL STIMULATION

(71) Applicant: Saudi Arabian Oil Company, Dhahran (SA)

(72) Inventor: Ahmed Abdullah Al-Ghamdi, Al Khobar (SA)

(21) Appl. No.: 18/521,576

(22) Filed: Nov. 28, 2023

(51) Int. Cl. E21B 43/25

(52) U.S. Cl. CPC E21B 43/25; G06Q 50/02; E21B 2200/20; E21B 2200/22

(57) ABSTRACT

Disclosed are methods, systems, and computer-readable media to perform operations including: receiving, by an artificial neural network (ANN) model, real-time well data of one or more wells, wherein the real-time well data comprises one or more of each well's upstream flowing pressure, upstream temperature, downstream flowing pressure, downstream temperature, flow rate, or choke size; and providing, by the ANN model, a ranked list of well candidates for well stimulation, wherein the well candidates are ranked based on a flow rate gain of the well candidates.

### TECHNICAL FIELD

This disclosure relates generally to well stimulation using an artificial intelligence (AI) system.

### BACKGROUND

Well stimulation is a process used in the oil and gas industry to enhance the production of hydrocarbons from reservoirs. It involves various techniques and methods to increase the flow of oil or natural gas from underground reservoirs. The goal of well stimulation is to improve the permeability of reservoir rocks and increase the flow of hydrocarbons to wellbores.

An existing approach for identifying candidate wells for well stimulation is a manual process requiring engineers and service company personnel to work together and understand reservoir rock composition, reservoir contents (oil, water, gas) composition, existing flow characteristics, reactions, and compatibility of reservoirs with stimulation acid, etc. This manual process is time-consuming, while slightest errors may lead to well stimulation failures.

### BRIEF DESCRIPTION OF THE FIGURES

FIG. 1 illustrates an example well stimulation recommendation system 100, according to some implementations.

FIG. 2 illustrates a flow chart for well stimulation recommendation, according to some implementations.

FIG. 3 illustrates another flow chart for well stimulation recommendations, according to some implementations.

FIG. 4 illustrates an example chatbot user interface enabled by a generative AI model, according to some implementations.

FIG. 5 illustrates hydrocarbon production operations that include both one or more field operations and one or more computational operations, which exchange information and control exploration for the production of hydrocarbons.

FIG. 6 is a schematic illustration of an example controller (or control system) that enables a well stimulation recommendation system.

### DETAILED DESCRIPTION

This disclosure describes methods and systems for generating a well stimulation recommendation. An ANN model is used to provide a ranked list of well candidates based on a flow rate gain or a production gain of the well candidates and a well stimulation recommendation, e.g., a type of well stimulation treatment and a substance applied in the well stimulation treatment. A generative AI model is used as a chatbot that interacts with users. For example, the generative AI model provides ranked well candidates and/or the well stimulation recommendation output by the ANN model as a response to a user request. The ANN model determines the ranking of well candidates and/or the well stimulation recommendation output based on real-time well data.

Some advantages of the present techniques include an improvement in the efficiency of well stimulation treatment. Compared to the existing manual process by engineers, the well stimulation recommendation system described herein can determine the causes of low production rates of available wells, and identify which wells have the potential to increase production rate post well stimulation. The well stimulation recommendation system can rank candidate wells to be prioritized for well stimulation treatment, to maximize the cost efficiency of well stimulation treatment. For example, wells having substantial production rate gain after well stimulation treatment are ranked higher than wells having a marginal substantial production rate gain after well stimulation treatment. The well stimulation recommendation system can accurately characterize well formation damage and accordingly recommend well stimulation treatment to restore and increase production.

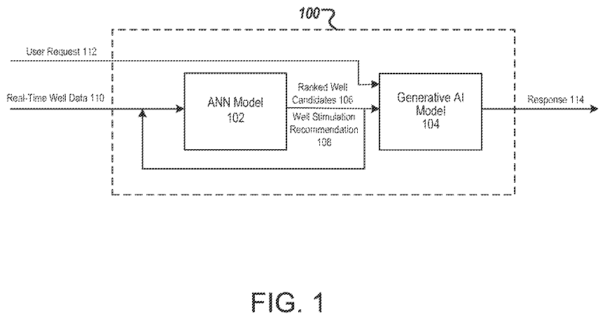

FIG. 1 illustrates an example well stimulation recommendation system 100, according to some implementations. In some implementations, the well stimulation recommendation system 100 includes multi-layer deep learning (DL) artificial neural network (ANN) model 102 and generative artificial intelligence (AI) model 104. An ANN, also referred to as a neural network, is a machine learning model that replicates the structure and function of biological neural networks in the human brain. The ANN includes interconnected artificial neurons (also referred to as nodes or units) organized into layers comprising an input layer, one or more hidden layers, and an output layer. Generative AI refers to a subset of AI that focuses on creating or generating new contents, often in the form of text, images, audio, or other data types, that is similar to content produced by humans. A generative AI system can use machine learning algorithms, e.g., deep learning techniques like neural networks, to generate new content autonomously based on patterns and data that the generative AI system has learned from training data.

The ANN model 102 is used to provide a ranked list of well candidates 106 for well stimulation, as well as well stimulation recommendations 108. In some implementations, well candidates 106 are ranked based on flow rate gain (production gain) post-stimulation. The flow rate gain post-stimulation refers to an increase in the flow rate of hydrocarbons (oil or natural gas) from a well after performing a well stimulation treatment. The well stimulation recommendations 108 include a type of well stimulation (e.g., hydraulic fracturing, acidizing, matrix stimulation, steam injection, Nitrogen or Carbon Dioxide (CO₂) injection, electric submersible pumps) and a substance (e.g., acid or another chemical, Nitrogen or CO₂, steam, etc.) used in this type of well stimulation.

The flow rate gain is the difference between the flow rate of a well after a well stimulation treatment and the flow rate of the well before the well stimulation treatment. The flow rate of a vertical well after a well stimulation treatment can be determined using Equation (1) below:

$$Q = \frac{- kA}{μ} \frac{( {p}_{b} - {p}_{a} )}{L} \qquad ( 1 )$$

Where Q is a flow rate; K is permeability; μ is viscosity; A is a cross-sectional area through which the fluid is flowing; P_{b}−Pₐ is a pressure drop across the porous medium; L is the length between the points a and b where the P_{b} and Pₐ are measured.

The flow rate of a horizontal well after a well stimulation treatment can be determined using Equation (2) below:

$$q = \frac{0.00708 {b}_{H} \sqrt{{k}_{x} {k}_{z}} ( \overline{p} - {p}_{wf} )}{B μ [ ln ( \frac{{A}^{1 / 2}}{{r}_{w}} ) + ln {C}_{H} - 0.75 + {s}_{p} + ( \frac{{b}_{H}}{{L}_{w}} ) {s}_{d} ]} \qquad ( 2 )$$

Where q is a flow rate; μ is viscosity; A is a cross-sectional area through which the fluid is flowing; b_{H} is the length in a direction parallel to a wellbore; kₓ is permeability in the x-direction; k_{z} is permeability in the z-direction; p̅ is volumetric average or static drainage-area pressure; p_{wf} is Bottom-Hole Pressure (BHP) in a wellbore; B is a formation volume factor; r_{w} is wellbore radius; Sₚ is a skin value (indicating reduced productivity) resulting from an incompletely perforated interval; S_{d} is a skin value caused by formation damage; L_{w} is a completed length of a horizontal well.

A type of well stimulation treatment can be one of: hydraulic fracturing (Fracking), acidizing, matrix stimulation, steam injection, Nitrogen or Carbon Dioxide (CO₂) injection, electric submersible pumps (ESPs), etc. Hydraulic fracturing involves injecting a high-pressure fluid (usually a mixture of water, sand, and chemicals) into a wellbore to create fractures in the reservoir rock. These fractures provide pathways for oil or gas to flow more easily into the wellbore, increasing production rates. Acidizing is a process where acid is pumped into the wellbore and reservoir to dissolve or react with minerals and rocks that may be obstructing the flow of hydrocarbons. Acidizing removes blockages and increase permeability. Matrix stimulation techniques involve injecting fluids, acids, or other chemicals into the reservoir to dissolve or dislodge materials that may be hindering the flow of oil or gas within the rock matrix. Steam injection, also known as steam stimulation or thermal recovery, is used in heavy oil reservoirs or oil sands. It involves injecting steam into the reservoir to reduce the viscosity of heavy crude oil, making it easier to extract and flow to the surface. Nitrogen or carbon dioxide (CO₂) can be injected into a well to improve reservoir pressure and displace hydrocarbons toward the wellbore. ESPs are electrical pumps placed downhole to lift oil or gas to the surface.

In some implementations, the ANN model 102 is trained with a large amount of data, including well information from an early exploration phase to a production phase. The large amount of data includes exploration and appraisal data, drilling parameters, open hole logging data, coring data, 3D static/dynamic model data, and production data. The exploration and appraisal data includes outcrop information/properties, subsurface seismic data, a reservoir structure, reservoir trap mechanism and areal extent, and an amplitude-porosity map. Drilling parameters include a rate of penetration, drilling fluid losses, cuttings analysis data, mud gas logs, measurement while drilling (MWD) parameters, and logging while drilling (LWD) parameters. The open hole logging data includes gamma-ray logs, saturation logs, density and neutron porosity logs, nuclear magnetic resonance, caliper, and all other relevant logs. The coring data includes porosity, permeability, relative permeability, wettability, capillary pressure, and core flooding data. The 3D static/dynamic model data shows how the well is positioned next to all other wells. The 3D static/dynamic model data can show variations in geology with spatial positions. The 3D static/dynamic model data can allow the ANN model 102 to understand how flow would be impacted post well stimulation treatment. For example, if a well stimulation treatment induces water into an oil well candidate after well stimulation treatment, the ANN model 102 would not recommend a stimulation treatment of the oil well candidate, as it is not desirable for water to be induced to an oil well. The 3D static/dynamic model data can enable the ANN model 102 to predict impacts on the whole field production resulting from an increase in production rate at one or more wells. The production data includes real-time well data, such as production rate, water cut, gas rate, upstream flowing pressure, downstream flowing pressure, upstream temperature, and downstream temperature. The ANN model 102 learns to understand and analyze real-time information about well behaviors using the production data as input. Thus, the ANN model 102 is trained using information related to well performance, reservoir characteristics, and fluid compatibility.

After the ANN model 102 is trained, real-time well data 110 of wells is input into the ANN model 102 to predict well candidates for well stimulation treatment. For example, one or more of a respective well's upstream flowing pressure, upstream temperature, downstream flowing pressure, downstream temperature, flow rate, or choke size is input into the ANN model 102, and a ranked list of well candidates 106 is output from the ANN model 102. The well candidates 106 are ranked based on flow rate gain post-stimulation, and a well having the highest flow rate gain post-stimulation is ranked first. In some implementations, the ANN model 102 further outputs a well stimulation recommendation, e.g., utilizing a mixture of 15% HCl acid and emulsified acid for deep penetration. For example, a well stimulation recommendation provides a treatment that can be performed at one or more wells to increase production at the one or more wells. The treatment can be automatically implemented at the well in real time. In some implementations, the ranked well candidates 106 (resultant flow rate gains) and well stimulation recommendations 108 (recommended well stimulation types and chemicals) are fed back into the ANN model 102 for continuous training of the ANN model 102.

The generative AI model 104 can generate human-like texts using natural language processing (NLP). For example, the generative AI model 104 can work as a chatbot that interacts with users. The user inputs a user request (e.g., “Please rank the stimulation candidates wells in Field SF in terms of the highest production gain”) 112 to the generative AI model 104. The generative AI model 104 outputs a response 114 (e.g., “The wells with highest anticipated production gain post-treatment are . . . ”) to the user request 112. The ANN model 102 is used to output ranked well candidates 106 and well stimulation recommendations 108, while the generative AI model 104 can communicate ranked well candidates 106 and well stimulation recommendations 108 to users, as the response 114, through a chatbot.

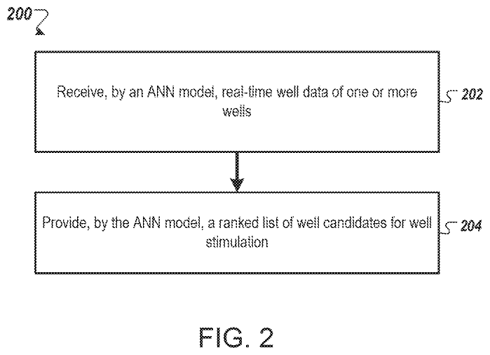

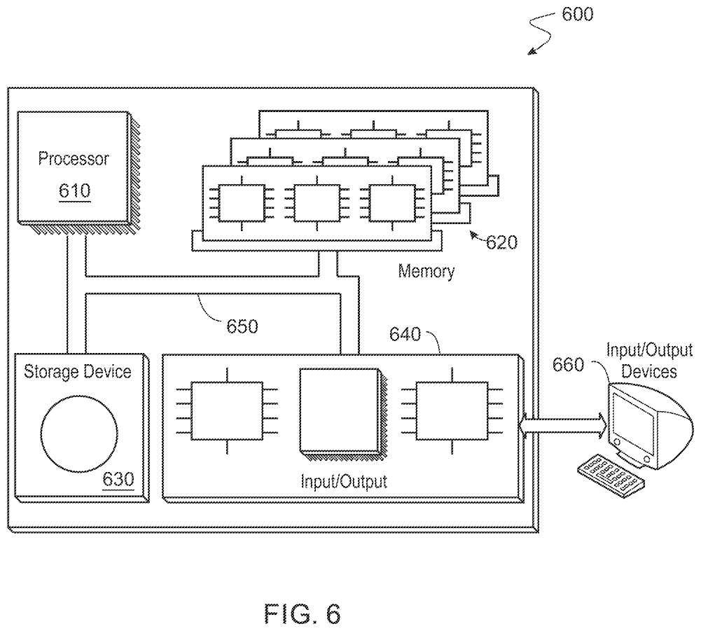

FIG. 2 illustrates a flow chart for well stimulation recommendation, according to some implementations. The process 200 is described as being performed by a computing device including one or more processors or a controller, such as controller 600 of FIG. 6. The example process 200 shown in FIG. 2 can be modified or reconfigured to include additional, fewer, or different steps (not shown in FIG. 2), which can be performed in the order shown or in a different order. The ANN model 102 is implemented on a computing device or a controller (e.g., controller 600 of FIG. 6).

At 202, an ANN model (e.g., ANN model 102 of FIG. 1) receives real-time well data (e.g., real-time well data 10) of one or more wells. The real-time well data of a respective well includes one or more of: an upstream flowing pressure, an upstream temperature, a downstream flowing pressure, a downstream temperature, a flow rate, or a choke size. In examples, real-time well data is the upstream flowing pressure, the upstream temperature, the downstream flowing pressure, the downstream temperature, the flow rate, the choke size, or any combinations thereof.

At 204, the ANN model provides a ranked list of well candidates (e.g., ranked well candidates 106 of FIG. 1) for well stimulation. The well candidates are ranked based on a flow rate gain (also referred to as “production gain” or “injection rate”) of the well candidates. The flow rate gain refers to a flow rate difference (increase) between the flow rate of a well prior to performing the recommended well stimulation treatment and the flow rate of the well after performing the recommended well stimulation treatment (assuming that the recommended well stimulation treatment is performed). The larger the flow rate gain, the higher the rank.

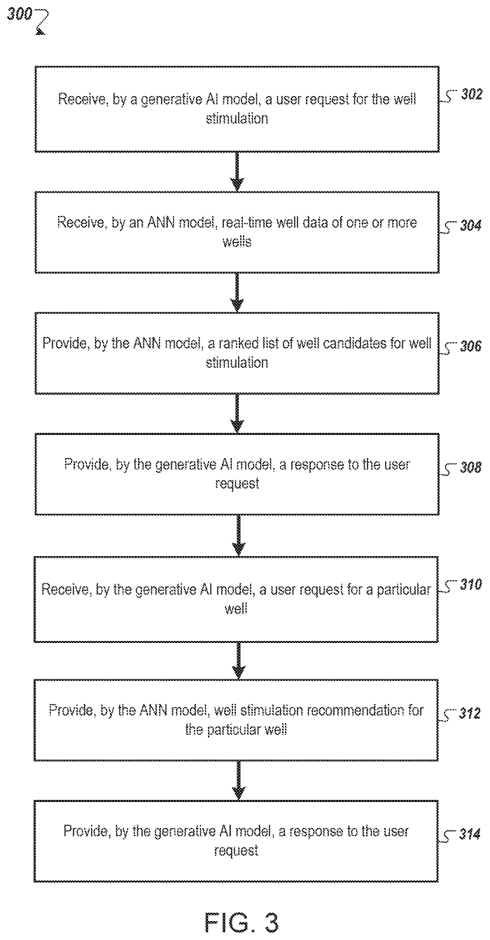

FIG. 3 illustrates another flow chart for well stimulation recommendations, according to some implementations. The process 300 is described as being performed by a computing device including one or more processors or a controller, such as controller 600 of FIG. 6. The example process 300 shown in FIG. 3 can be modified or reconfigured to include additional, fewer, or different steps (not shown in FIG. 3), which can be performed in the order shown or in a different order. The ANN model 102 and the generative AI model 104 are implemented on a computing device or a controller (e.g., controller 600 of FIG. 6).

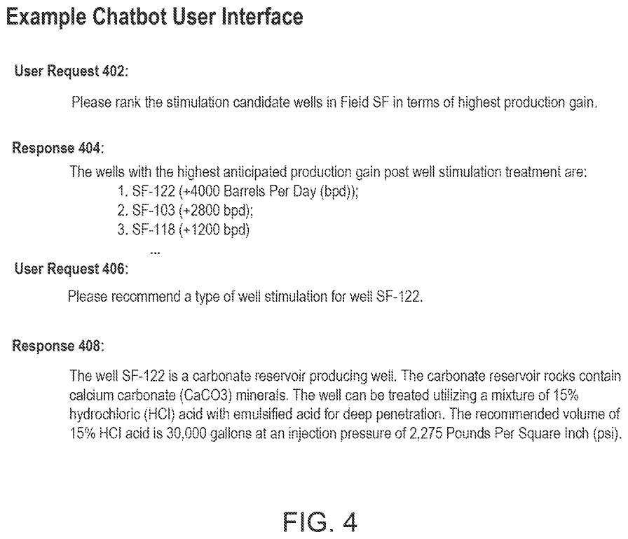

At 302, a generative AI model (e.g., the generative AI model 104 of FIG. 1) receives a user request (e.g., the user request 112 of FIG. 1) for well stimulation. Referring to FIG. 4, the user sends a request 402 to the ANN model. The request 402, e.g., is “Please rank the stimulation candidate wells in Field SF in terms of highest production gain.”

At 304, the ANN model (e.g., ANN model 102 of FIG. 1) receives real-time well data (e.g., real-time well data 10) of one or more wells (e.g., stimulation candidate wells in Field SF). The real-time well data of a respective well includes one or more of: an upstream flowing pressure, an upstream temperature, a downstream flowing pressure, a downstream temperature, a flow rate, or a choke size. In examples, real-time well data is the upstream flowing pressure, the upstream temperature, the downstream flowing pressure, the downstream temperature, the flow rate, the choke size, or any combinations thereof.

At 306, the ANN model provides a ranked list of well candidates (e.g., ranked well candidates 106 of FIG. 1) for well stimulation. The well candidates are ranked based on a flow rate gain of the well candidates. The flow rate gain refers to a flow rate difference (increase) between the flow rate of a well prior to performing the treatment associated with the well stimulation recommendation and the flow rate of the well after performing the treatment associated with the well stimulation recommendation (assuming that the recommended well stimulation treatment is performed). The larger the flow rate gain, the higher the rank.

At 308, the generative AI model provides a response (e.g., response 114 of FIG. 1) to the user request. The response includes the ranked list of well candidates for well stimulation output by the ANN model at 306. Referring to FIG. 4, the user receives a response 404 from the generative AI model. The response 404, e.g., is “The wells with the highest anticipated production gain post well stimulation treatment are: 1. SF-122 (+4000 Barrels Per Day (bpd)); 2. SF-103 (+2800 bpd); 3. SF-118 (+1200 bpd) . . . ”

At 310, a generative AI model (e.g., the generative AI model 104 of FIG. 1) receives a user request (e.g., the user request 112 of FIG. 1) for a particular well (e.g., well SF-122). Referring to FIG. 4, the user sends a request 406 to the ANN model. The request 406, e.g., is “Please recommend a type of well stimulation for well SF-122.”

At 312, the ANN model provides well stimulation recommendation (e.g., well stimulation recommendation 108 of FIG. 1) for the particular well. The well stimulation recommendation includes one or more of: a brief introduction of the particular well, a type of well stimulation treatment, an amount of substance to be applied in this type of well stimulation treatment, and a condition of performing the well stimulation treatment.

At 314, the generative AI model provides a response (e.g., response 114 of FIG. 1) to the user request. The response includes well stimulation recommendation provided by the ANN model at 312. Referring to FIG. 4, the user receives a response 408 from the generative AI model. The response 408, e.g., is “The well SF-122 is a carbonate reservoir producing well. The carbonate reservoir rocks contain calcium carbonate (CaCO3) minerals. The well can be treated utilizing a mixture of 15% hydrochloric (HCl) acid with emulsified acid for deep penetration. The recommended volume of 15% HCl acid is 30,000 gallons at an injection pressure of 2,275 Pounds Per Square Inch (psi).”

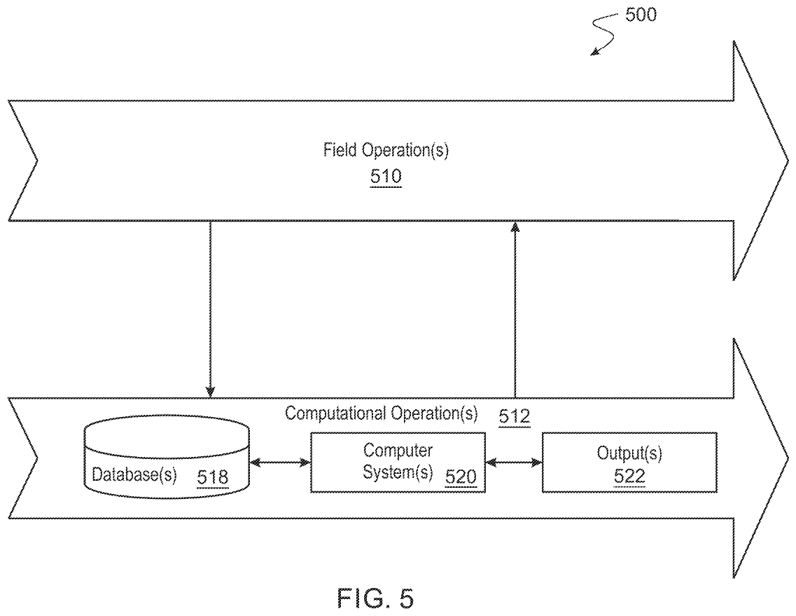

FIG. 5 illustrates hydrocarbon production operations 500 that include both one or more field operations 510 and one or more computational operations 512, which exchange information and control exploration for the production of hydrocarbons. In some implementations, outputs of techniques of the present disclosure can be performed before, during, or in combination with the hydrocarbon production operations 500, specifically, for example, either as field operations 510 or computational operations 512, or both.

Examples of field operations 510 include forming/drilling a wellbore, hydraulic fracturing, producing through the wellbore, injecting fluids (such as water) through the wellbore, to name a few. In some implementations, methods of the present disclosure can trigger or control the field operations 510. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 510 and responsively triggering the field operations 510 including, for example, generating plans and signals that provide feedback to and control physical components of the field operations 510. Alternatively or in addition, the field operations 510 can trigger the methods of the present disclosure. For example, implementing physical components (including, for example, hardware, such as sensors) deployed in the field operations 510 can generate plans and signals that can be provided as input or feedback (or both) to the methods of the present disclosure.

Examples of computational operations 512 include one or more computer systems 520 that include one or more processors and computer-readable media (e.g., non-transitory computer-readable media) operatively coupled to the one or more processors to execute computer operations to perform the methods of the present disclosure. The computational operations 512 can be implemented using one or more databases 518, which store data received from the field operations 510 and/or generated internally within the computational operations 512 (e.g., by implementing the methods of the present disclosure) or both. For example, the one or more computer systems 520 process inputs from the field operations 510 to assess conditions in the physical world, the outputs of which are stored in the databases 518. For example, seismic sensors of the field operations 510 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 512 where they are stored in the databases 518 and analyzed by the one or more computer systems 520.

In some implementations, one or more outputs 522 generated by the one or more computer systems 520 can be provided as feedback/input to the field operations 510 (either as direct input or stored in the databases 518). The field operations 510 can use the feedback/input to control physical components used to perform the field operations 510 in the real world.

For example, the computational operations 512 can process the seismic data to generate three-dimensional (3D) maps of the subsurface formation. The computational operations 512 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 512 to process new information about the formation and control the drilling to adjust to the observed conditions in real-time.

The one or more computer systems 520 can update the 3D maps of the subsurface formation as information from one exploration well is received and the computational operations 512 can adjust the location of the next exploration well based on the updated 3D maps. Similarly, the data received from production operations can be used by the computational operations 512 to control components of the production operations. For example, production well and pipeline data can be analyzed to predict slugging in pipelines leading to a refinery and the computational operations 512 can control machine operated valves upstream of the refinery to reduce the likelihood of plant disruptions that run the risk of taking the plant offline.

In some implementations of the computational operations 512, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

FIG. 6 is a schematic illustration of an example controller 600 (or control system) that enables a well stimulation recommendation system. For example, the controller 600 may be operable according to the process 200 of FIG. 2 and process 300 of FIG. 3. The controller 600 is intended to include various forms of digital computers, such as printed circuit boards (PCB), processors, digital circuitry, or otherwise parts of a system for supply chain alert management. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 600 includes a processor 610, a memory 620, a storage device 630, and an input/output interface 640 communicatively coupled with input/output devices 660 (for example, displays, keyboards, measurement devices, sensors, valves, pumps). Each of the components 610, 620, 630, and 640 are interconnected using a system bus 650. The processor 610 is capable of processing instructions for execution within the controller 600. The processor may be designed using any of a number of architectures. For example, the processor 610 may be a CISC (Complex Instruction Set Computers) processor, a RISC (Reduced Instruction Set Computer) processor, or a MISC (Minimal Instruction Set Computer) processor.

In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output interface 640.

The memory 620 stores information within the controller 600. In one implementation, the memory 620 is a computer-readable medium. In one implementation, the memory 620 is a volatile memory unit. In another implementation, the memory 620 is a nonvolatile memory unit.

The storage device 630 is capable of providing mass storage for the controller 600. In one implementation, the storage device 630 is a computer-readable medium. In various different implementations, the storage device 630 may be a floppy disk device, a hard disk device, an optical disk device, or a tape device.

The input/output interface 640 provides input/output operations for the controller 600. In one implementation, the input/output devices 660 includes a keyboard and/or pointing device. In another implementation, the input/output devices 660 includes a display unit for displaying graphical user interfaces.

There can be any number of controllers 600 associated with, or external to, a computer system containing controller 600, with each controller 600 communicating over a network. Further, the terms “client,” “user,” and other appropriate terminology can be used interchangeably, as appropriate, without departing from the scope of the present disclosure. Moreover, the present disclosure contemplates that many users can use one controller 600 and one user can use multiple controllers 600.

### EMBODIMENTS/EXAMPLES

According to some non-limiting embodiments or examples, provided is a computer-implemented method for well stimulation, comprising: obtaining, by an artificial neural network (ANN) model, real-time well data of one or more wells, wherein the real-time well data of a respective well comprises one or more of: an upstream flowing pressure, an upstream temperature, a downstream flowing pressure, a downstream temperature, a flow rate, or a choke size; and providing, by the ANN model, a ranked list of well candidates for well stimulation, wherein the well candidates are ranked based on a flow rate gain of the well candidates.

According to some non-limiting embodiments or examples, provided is an apparatus comprising a non-transitory, computer readable, storage medium that stores instructions that, when executed by at least one processor, cause the at least one processor to perform operations comprising: obtaining, by an artificial neural network (ANN) model, real-time well data of one or more wells, wherein the real-time well data of a respective well comprises one or more of: an upstream flowing pressure, an upstream temperature, a downstream flowing pressure, a downstream temperature, a flow rate, or a choke size; and providing, by the ANN model, a ranked list of well candidates for well stimulation, wherein the well candidates are ranked based on a flow rate gain of the well candidates.

According to some non-limiting embodiments or examples, provided is a system, comprising: one or more memory modules; one or more hardware processors communicably coupled to the one or more memory modules, the one or more hardware processors configured to execute instructions stored on the one or more memory models to perform operations comprising: obtaining, by an artificial neural network (ANN) model, real-time well data of one or more wells, wherein the real-time well data of a respective well comprises one or more of: an upstream flowing pressure, an upstream temperature, a downstream flowing pressure, a downstream temperature, a flow rate, or a choke size; and providing, by the ANN model, a ranked list of well candidates for well stimulation, wherein the well candidates are ranked based on a flow rate gain of the well candidates.

Further non-limiting aspects or embodiments are set forth in the following numbered embodiments:

Embodiment 1: A computer-implemented method for well stimulation, comprising:
obtaining, by an artificial neural network (ANN) model, real-time well data of one or more wells, wherein the real-time well data of a respective well comprises one or more of: an upstream flowing pressure, an upstream temperature, a downstream flowing pressure, a downstream temperature, a flow rate, or a choke size; and providing, by the ANN model, a ranked list of well candidates for well stimulation, wherein the well candidates are ranked based on a flow rate gain of the well candidates.

Embodiment 2: The computer-implemented method of Embodiment 1, further comprising providing, by the ANN model, one or more well stimulation recommendations for treating the well candidates.

Embodiment 3: The computer-implemented method of Embodiment 2, wherein the one or more well stimulation recommendations comprise a type of well stimulation treatment and a substance used in this type of well stimulation treatment.

Embodiment 4: The computer-implemented method of Embodiment 3, wherein the ranked list of well candidates and the one or more well stimulation recommendations are fed back to the ANN model for continuous training of the ANN model.

Embodiment 5: The computer-implemented method of Embodiment 2, further comprising: receiving, by a generative artificial intelligence (AI) model, a user request for the one or more well stimulation recommendations; and providing, by the generative AI model, a response to the user request, wherein the response comprises the ranked list of well candidates for well stimulation or the one or more well stimulation recommendations.

Embodiment 6: The computer-implemented method of any one of previous Embodiments, wherein the ANN model is trained using well data comprising one or more of: exploration and appraisal data, one or more drilling parameters, open hole logging data, coring data, 3Dstatic/dynamic model data, or production data.

Embodiment 7: The computer-implemented method of Embodiment 6, wherein the exploration and appraisal data comprises one or more of: outcrop information/properties, subsurface seismic data, a reservoir structure, reservoir trap mechanism and areal extent, or an amplitude-porosity map.

Embodiment 8: The computer-implemented method of Embodiment 6, wherein the one or more drilling parameters comprise one or more of: a rate of penetration, drilling fluid losses, cuttings analysis data, mud gas logs, measurement while drilling (MWD) parameters, or logging while drilling (LWD) parameters.

Embodiment 9: The computer-implemented method of Embodiment 6, wherein the open hole logging data comprises gamma-ray logs, saturation logs, density and neutron porosity logs, nuclear magnetic resonance, caliper, or all other relevant logs.

Embodiment 10: The computer-implemented method of Embodiment 6, wherein the coring data comprises one or more of: porosity, permeability, relative permeability, wettability, capillary pressure, or core flooding data.

Embodiment 11: The computer-implemented method of Embodiment 6, wherein the production data comprises one or more of: a production rate, water cut, a gas rate, the upstream flowing pressure, the downstream flowing pressure, the upstream temperature, or the downstream temperature.

Embodiment 12: An apparatus comprising a non-transitory, computer readable, storage medium that stores instructions that, when executed by at least one processor, cause the at least one processor to perform operations comprising: obtaining, by an artificial neural network (ANN) model, real-time well data of one or more wells, wherein the real-time well data of a respective well comprises one or more of: an upstream flowing pressure, an upstream temperature, a downstream flowing pressure, a downstream temperature, a flow rate, or a choke size; and providing, by the ANN model, a ranked list of well candidates for well stimulation, wherein the well candidates are ranked based on a flow rate gain of the well candidates.

Embodiment 13: The apparatus of Embodiment 12, the operations further comprising providing, by the ANN model, one or more well stimulation recommendations for treating the well candidates.

Embodiment 14: The apparatus of Embodiment 13, wherein the one or more well stimulation recommendations comprise a type of well stimulation treatment and a substance used in this type of well stimulation treatment.

Embodiment 15: The apparatus of Embodiment 14, wherein the ranked list of well candidates and the one or more well stimulation recommendations are fed back to the ANN model for continuous training of the ANN model.

Embodiment 16: The apparatus of Embodiment 13, the operations further comprising: receiving, by a generative artificial intelligence (AI) model, a user request for the one or more well stimulation recommendations; and providing, by the generative AI model, a response to the user request, wherein the response comprises the ranked list of well candidates for well stimulation or the one or more well stimulation recommendations.

Embodiment 17: The apparatus of any one of Embodiments 12-16, wherein the ANN model is trained using well data comprising one or more of: exploration and appraisal data, one or more drilling parameters, open hole logging data, coring data, 3Dstatic/dynamic model data, or production data.

Embodiment 18: The apparatus of Embodiment 17, wherein the exploration and appraisal data comprises one or more of: outcrop information, subsurface seismic data, a reservoir structure, reservoir trap mechanism and areal extent, or an amplitude-porosity map.

Embodiment 19: The apparatus of Embodiment 17, wherein the one or more drilling parameters comprise one or more of: a rate of penetration, drilling fluid losses, cuttings analysis data, mud gas logs, measurement while drilling (MWD) parameters, or logging while drilling (LWD) parameters.

Embodiment 20: A system, comprising: one or more memory modules; one or more hardware processors communicably coupled to the one or more memory modules, the one or more hardware processors configured to execute instructions stored on the one or more memory models to perform operations comprising: obtaining, by an artificial neural network (ANN) model, real-time well data of one or more wells, wherein the real-time well data of a respective well comprises one or more of: an upstream flowing pressure, an upstream temperature, a downstream flowing pressure, a downstream temperature, a flow rate, or a choke size; and providing, by the ANN model, a ranked list of well candidates for well stimulation, wherein the well candidates are ranked based on a flow rate gain of the well candidates.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship. Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Various components may be described as performing a task or tasks, for convenience in the description. Such descriptions should be interpreted as including the phrase “configured to.” Reciting a component that is configured to perform one or more tasks is expressly intended not to invoke 35 USC § 112 (f) interpretation for that component.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

We claim:

1. A computer-implemented method for well stimulation, comprising:
obtaining, by an artificial neural network (ANN) model, real-time well data of one or more wells, wherein the real-time well data of a respective well comprises one or more of: an upstream flowing pressure, an upstream temperature, a downstream flowing pressure, a downstream temperature, a flow rate, or a choke size; and
providing, by the ANN model, a ranked list of well candidates for well stimulation, wherein the well candidates are ranked based on a flow rate gain of the well candidates.

2. The computer-implemented method of claim 1, further comprising providing, by the ANN model, one or more well stimulation recommendations for treating the well candidates.

3. The computer-implemented method of claim 2, wherein the one or more well stimulation recommendations comprise a type of well stimulation treatment and a substance used in this type of well stimulation treatment.

4. The computer-implemented method of claim 3, wherein the ranked list of well candidates and the one or more well stimulation recommendations are fed back to the ANN model for continuous training of the ANN model.

5. The computer-implemented method of claim 2, further comprising:
receiving, by a generative artificial intelligence (AI) model, a user request for the one or more well stimulation recommendations; and
providing, by the generative AI model, a response to the user request, wherein the response comprises the ranked list of well candidates for well stimulation or the one or more well stimulation recommendations.

6. The computer-implemented method of claim 1, wherein the ANN model is trained using well data comprising one or more of: exploration and appraisal data, one or more drilling parameters, open hole logging data, coring data, 3Dstatic/dynamic model data, or production data.

7. The computer-implemented method of claim 6, wherein the exploration and appraisal data comprises one or more of: outcrop information/properties, subsurface seismic data, a reservoir structure, reservoir trap mechanism and areal extent, or an amplitude-porosity map.

8. The computer-implemented method of claim 6, wherein the one or more drilling parameters comprise one or more of: a rate of penetration, drilling fluid losses, cuttings analysis data, mud gas logs, measurement while drilling (MWD) parameters, or logging while drilling (LWD) parameters.

9. The computer-implemented method of claim 6, wherein the open hole logging data comprises gamma-ray logs, saturation logs, density and neutron porosity logs, nuclear magnetic resonance, caliper, or all other relevant logs.

10. The computer-implemented method of claim 6, wherein the coring data comprises one or more of: porosity, permeability, relative permeability, wettability, capillary pressure, or core flooding data.

11. The computer-implemented method of claim 6, wherein the production data comprises one or more of: a production rate, water cut, a gas rate, the upstream flowing pressure, the downstream flowing pressure, the upstream temperature, or the downstream temperature.

12. An apparatus comprising a non-transitory, computer readable, storage medium that stores instructions that, when executed by at least one processor, cause the at least one processor to perform operations comprising:
obtaining, by an artificial neural network (ANN) model, real-time well data of one or more wells, wherein the real-time well data of a respective well comprises one or more of: an upstream flowing pressure, an upstream temperature, a downstream flowing pressure, a downstream temperature, a flow rate, or a choke size; and
providing, by the ANN model, a ranked list of well candidates for well stimulation, wherein the well candidates are ranked based on a flow rate gain of the well candidates.

13. The apparatus of claim 12, the operations further comprising providing, by the ANN model, one or more well stimulation recommendations for treating the well candidates.

14. The apparatus of claim 13, wherein the one or more well stimulation recommendations comprise a type of well stimulation treatment and a substance used in this type of well stimulation treatment.

15. The apparatus of claim 14, wherein the ranked list of well candidates and the one or more well stimulation recommendations are fed back to the ANN model for continuous training of the ANN model.

16. The apparatus of claim 13, the operations further comprising:
receiving, by a generative artificial intelligence (AI) model, a user request for the one or more well stimulation recommendations; and
providing, by the generative AI model, a response to the user request, wherein the response comprises the ranked list of well candidates for well stimulation or the one or more well stimulation recommendations.

17. The apparatus of claim 12, wherein the ANN model is trained using well data comprising one or more of: exploration and appraisal data, one or more drilling parameters, open hole logging data, coring data, 3D static/dynamic model data, or production data.

18. The apparatus of claim 17, wherein the exploration and appraisal data comprises one or more of: outcrop information, subsurface seismic data, a reservoir structure, reservoir trap mechanism and areal extent, or an amplitude-porosity map.

19. The apparatus of claim 17, wherein the one or more drilling parameters comprise one or more of: a rate of penetration, drilling fluid losses, cuttings analysis data, mud gas logs, measurement while drilling (MWD) parameters, or logging while drilling (LWD) parameters.

20. A system, comprising:
one or more memory modules;
one or more hardware processors communicably coupled to the one or more memory modules, the one or more hardware processors configured to execute instructions stored on the one or more memory modules to perform operations comprising:
obtaining, by an artificial neural network (ANN) model, real-time well data of one or more wells, wherein the real-time well data of a respective well comprises one or more of: an upstream flowing pressure, an upstream temperature, a downstream flowing pressure, a downstream temperature, a flow rate, or a choke size; and
providing, by the ANN model, a ranked list of well candidates for well stimulation, wherein the well candidates are ranked based on a flow rate gain of the well candidates.
